(19) United States
(12) Patent Application Publication
(10) Pub. No.: US 2012/0196146 A1
(43) Pub. Date: Aug. 2, 2012

(54) GAS TURBINE ENGINE COMPONENTS INCLUDING CARBON NANOFIBER COMPOSITES

(76) Inventor: Edward Claude Rice, Indianapolis, IN (US)

(21) Appl. No.: 13/337,108

(22) Filed: Dec. 24, 2011

Related U.S. Application Data
(60) Provisional application No. 61/428,738, filed on Dec. 30, 2010.

(51) Int. Cl. F01D 5/14; C04B 35/80; B32B 3/26; B32B 5/18; B82Y 30/00

(52) U.S. Cl. 428/613; 416/241 R; 428/71; 501/95.2; 977/742; 977/750; 977/902; 977/735; 977/779

(57) ABSTRACT

One embodiment is a gas turbine engine component including a metal foam nanofiber composite. Another embodiment is a gas turbine engine component including a ceramic foam nanofiber composite. Other embodiments include unique gas turbine engine components including foam nanofiber composites.

### CROSS REFERENCE TO RELATED APPLICATIONS

The present application claims benefit of U.S. Provisional Patent Application No. 61/428,738, filed Dec. 30, 2010, entitled GAS TURBINE ENGINE COMPONENTS INCLUDING CARBON NANOFIBER COMPOSITES, which is incorporated herein by reference.

### TECHNICAL FIELD

The technical field relates to gas turbine engine components including carbon nanofiber composites.

### BACKGROUND

Gas turbine engines include a large number of components such as blades, vanes, shafts, discs, rotors, casings, struts, fans, compressors, turbines, and nozzles to name a few examples. Gas turbine engine components are often subjected to high temperature and/or high stress environments. At the same time the mass and weight of gas turbine engine components limits their performance. There is a longstanding need for gas turbine engine components which have reduced mass or weight characteristics, and yet still have acceptable or superior performance characteristics.

### SUMMARY

One embodiment is a gas turbine engine component including a metal foam nanofiber composite. Another embodiment is a gas turbine engine component including a ceramic foam nanofiber composite. Other embodiments include unique gas turbine engine components including foam nanofiber composites. Further embodiments, forms, objects, features, advantages, aspects, embodiments and benefits shall become apparent from the following descriptions, drawings, and claims.

### BRIEF DESCRIPTION OF THE DRAWINGS

FIG. 1 is partial cutaway view of some aspects of a non-limiting example of a turbine blade for a gas turbine engine according to one embodiment of the present invention.

FIG. 2 is a view of some aspects of a non-limiting example of a portion of a composite according to one embodiment of the present invention.

FIG. 3 is a view of some aspects of a non-limiting example of a portion of a composite according to one embodiment of the present invention.

FIGS. 4-9 illustrate some aspects of non-limiting examples of operations and operation states in a process of forming the turbine blade illustrated in FIG. 1 according to embodiments of the present invention.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention illustrated therein being contemplated as would normally occur to one skilled in the art to which the invention relates.

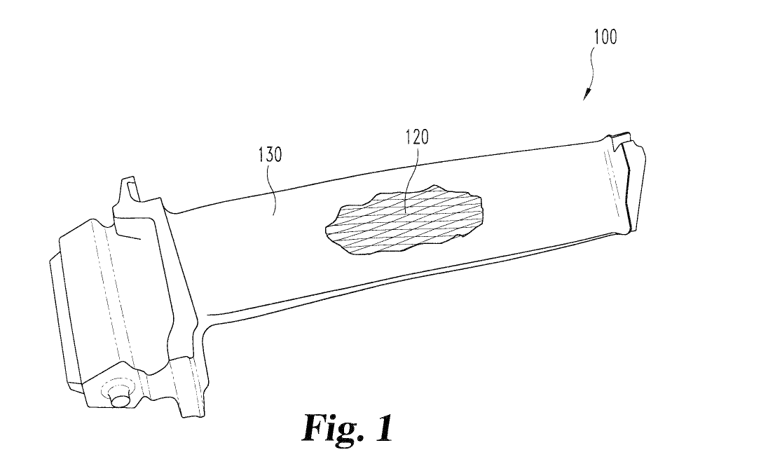

With reference to FIG. 1, there are illustrated some aspects of a non-limiting example of a turbine blade 100 for a gas turbine engine according to one embodiment of the present invention. As illustrated in the cutaway portion, the internal structure of blade 100 includes a foam nanofiber composite 120 forming the body of blade 100, and a skin 130 surrounds the internal structure (e.g., body) of blade 100. In one embodiment, composite 120 is a composite of metal foam and carbon nanofibers. In another embodiment, composite 120 is a composite of ceramic foam and carbon nanofibers. Composite 120 may comprise a portion, or substantially all of the internal structure of blade 100. Skin 130 is preferably a composite of metal and carbon nanofiber, or a composite of ceramic and carbon nanofiber, though it could also be formed of other materials, including conventional materials such as metals, alloys, or ceramics. In some embodiments, one or more coatings and/or other surface treatments may be provided on skin 130. It should be understood that blade 100 is one exemplary gas turbine engine component according to the present invention, and that a variety of additional gas turbine engine components including a foam nanofiber composite are also contemplated, for example, blades, vanes, shafts, discs, rotors, casings, struts, fans, compressors, turbines, and nozzles to name a few examples.

Metal foams, also known as metallic foams or metfoams, are cellular materials including metals or metal alloys having a significant percentage of their volume constituting pores or cells. The pores can be isolated from one another as in a closed-cell foam, can form an interconnected network as in an open-cell foam, or can include both characteristics. Metal foams may have a high porosity −90% or more of their volume may be void spaces, though a variety of other porosities are possible. Metal foams can be formed from a variety of metals and alloys including aluminum, copper, chromium, iron, nickel, magnesium, steel, titanium, yttrium, zinc, and alloys thereof to name several examples. Metal foams may have densities as low as about 10% or less of their traditionally fabricated constituent metals or alloys.

Ceramic foams are cellular materials including ceramic having a significant percentage of its volume constituting pores or cells. The pores can be isolated from one another as in a closed-cell foam, can form an interconnected network as in an open-cell foam, or can include both characteristics. Ceramic foams may have a high porosity, 90% or more of their volume may be void spaces, though a variety of porosities are possible. Ceramic foams can include a variety of oxide and nonoxide ceramics. Examples of ceramic foam materials include, for example and without limitation, silicone carbide (SiC), aluminum oxide and/or tungsten carbide.

As used herein, nanofibers or carbon nanofibers are nanoscale carbon structures—carbon nanomaterials—that may be used individually and/or in combination to form larger structures and/or to be interspersed between other materials. As used herein, “nanofibers or carbon nanofibers” include a broader class of carbon nanomaterials than nanofibers themselves, and as used herein, include carbon nanotubes, such as single-walled carbon nanotubes, and multi-walled carbon nanotubes, carbon nanorods, carbon buckyballs (spherical fullerenes, including buckminsterfullerenes, e.g., C60, C70 and other carbon fullerenes), other carbon nanomaterials not mentioned herein and combinations and mixtures of these materials. Other nanomaterials include, for example and without limitation, nanoclay. Carbon nanofibers typically have a diameter on the order of nanometers and a high aspect ratio. For example, single-walled carbon nanotubes have been measured to have a diameter of about 1.3 nm and an aspect ratio of about 1000. Other carbon nanotubes have been measured to be about 100 nm in diameter and 1-5 μm in length. Still other carbon nanotubes have been measured to be about 100 nm in diameter and 5-10 μm in length. Carbon nanofibers can be produced using a variety of techniques including, for example, high pressure conversion techniques, laser ablation or vaporization techniques, chemical vapor deposition techniques (such as plasma enhanced chemical vapor deposition techniques, and furnace chemical vapor deposition techniques), arc discharge techniques and others.

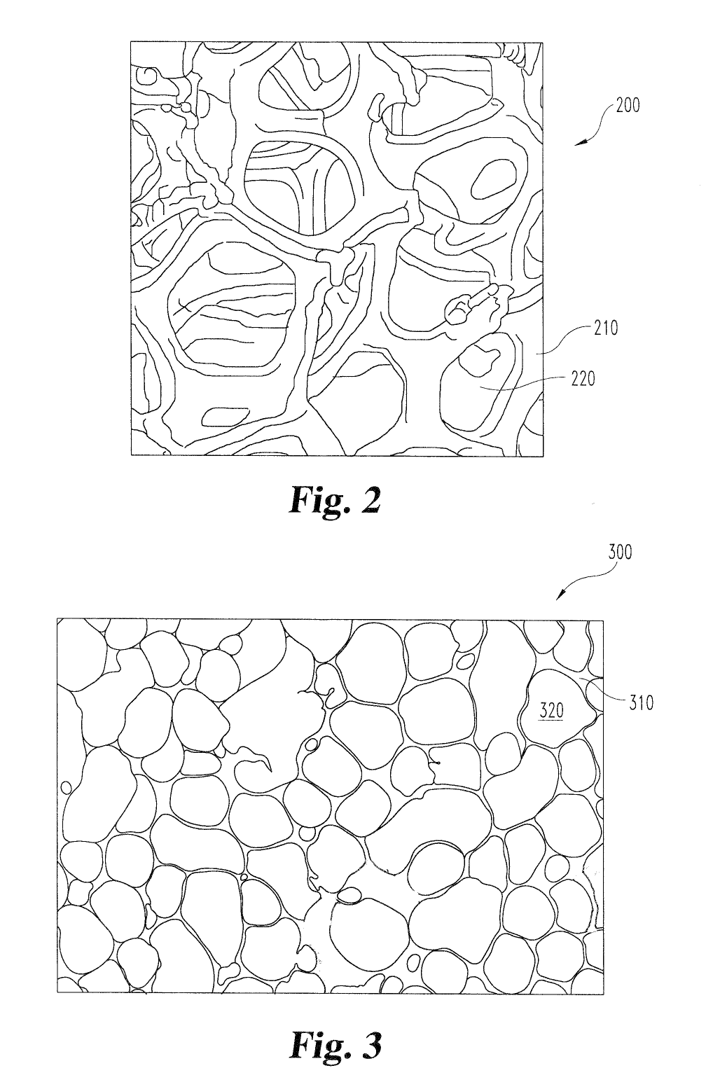

With reference to FIG. 2 there are illustrated some aspects of a non-limiting example of a portion of a foam nanofiber composite 200 in accordance with an embodiment of the present invention. Nanofiber composite 200 may be used to form the internal structure, e.g., body, of a gas turbine engine component, such as turbine blade 100. Composite 200 is an open cell foam where pores, such as pore 220, are interconnected with one another. In one embodiment composite material 210 is a composite of metal foam and carbon nanofibers. In another embodiment composite material 210 is a composite of ceramic foam and carbon nanofibers. The nanofibers are preferably distributed substantially randomly throughout composite material 210. In certain embodiments the composite material includes carbon nanotubes. In some embodiments the composite material includes single walled carbon nanotubes. In further embodiments the composite material includes multi-walled carbon nanotubes. In other embodiments, the composite material includes carbon buckyballs. In additional embodiments the carbon nanofibers of the composite material consist essentially of a particular carbon nanofiber such as carbon nanotubes, single-walled carbon nanotubes, multi-walled carbon nanotubes or carbon buckyballs. In additional embodiments the carbon nanofibers of the composite material are produced by a particular technique, for example, carbon nanotubes prepared by plasma enhanced chemical vapor deposition, carbon nanotubes prepared by furnace chemical vapor deposition, or combinations of nanotubes prepared by these techniques.

With reference to FIG. 3 there are illustrated some aspects of a non-limiting example of a portion of a nanofiber composite 300 in accordance with an embodiment of the present invention. Nanofiber composite 300 may be used to form the internal structure, e.g., body of a gas turbine engine component, such as turbine blade 100. Composite 300 is a closed cell foam where pores, such as pore 320 are not interconnected with one another. In one embodiment, composite material 310 is a composite of metal foam and carbon nanofibers. In another embodiment composite material 310 is a is a composite of ceramic foam and carbon nanofibers. The nanofibers are preferably distributed substantially randomly throughout composite material 310. In certain embodiments the composite material includes carbon nanotubes. In some embodiments the composite material includes single walled carbon nanotubes. In further embodiments the composite material includes multi-walled carbon nanotubes. In other embodiments, the composite material includes carbon buckyballs. In additional embodiments the carbon nanofibers of the composite material consist essentially of a particular carbon nanofiber such as carbon nanotubes, single-walled carbon nanotubes, multi-walled carbon nanotubes or carbon buckyballs. In additional embodiments the carbon nanofibers of the composite material are produced by a particular technique, for example, carbon nanotubes prepared by plasma enhanced chemical vapor deposition, carbon nanotubes prepared by furnace chemical vapor deposition, or combinations of nanotubes prepared by these techniques.

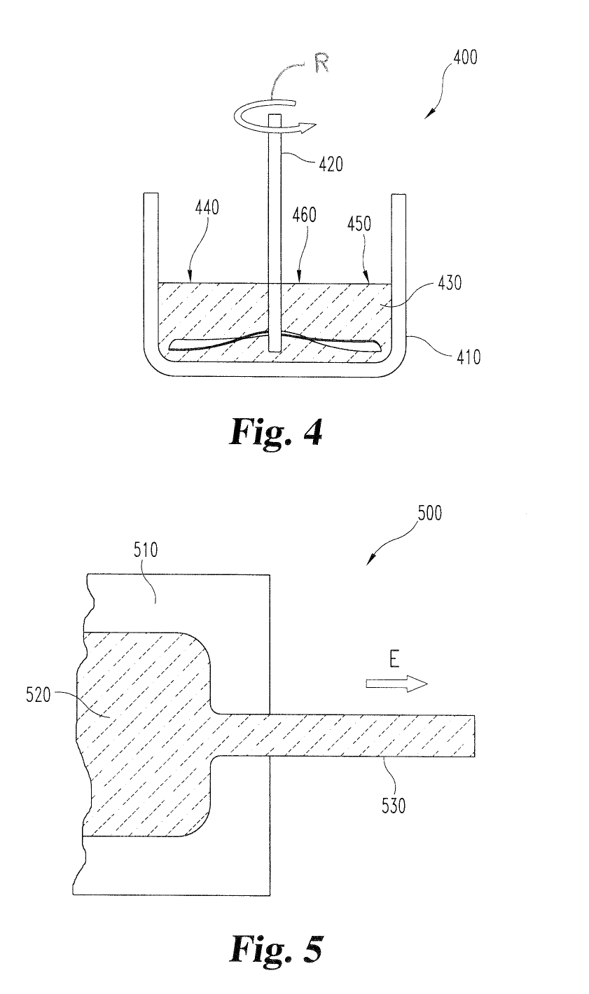

With reference to FIGS. 4-9 there is illustrated some aspects of a non-limiting example of an exemplary process for making a gas turbine engine component according to an embodiment the present invention. With reference to FIG. 4, mixing operation 400 is performed where powdered metal or alloy 440 (for example an aluminum alloy), foaming agent 450 (for example TiH₂, carbonates, or nitrates), and nanofibers 460 are combined in mixing vessel 410 and mixed using impeller 420 which rotates in the direction indicated by arrow R. Articles such as steel ball bearings may also be placed in the vessel to facilitate mixing. Mixing operation 400 produces a mixture 430 of metal or alloy 440, foaming agent 450, and nanofibers 460. The amount of nanofiber added to the mixture can be varied according to the desired properties of the composite component to be produced. In one embodiment, the nanofibers are in a powder-like form which has been collected from a chemical vapor deposition process, and the amount of nanofiber added to the mixture is about 10% by mass. In various embodiments, greater or lesser percentages of nanofiber may be employed. The amount of foaming agent used, if any, may vary with the needs of the application, e.g., with the desired foam density.

With reference to FIG. 5 there is illustrated a compaction and extrusion operation 500 is which the mixture of metal or alloy 440, foaming agent 450, and nanofibers 460 is now in a form where it has been compacted inside an extruder 510. The compacted mixture is designated 520. Mixture 520 is extruded from extruder 510 to produce a piece of extruded mixture 530 that has a near theoretical density, e.g., nearly 100% in some embodiments.

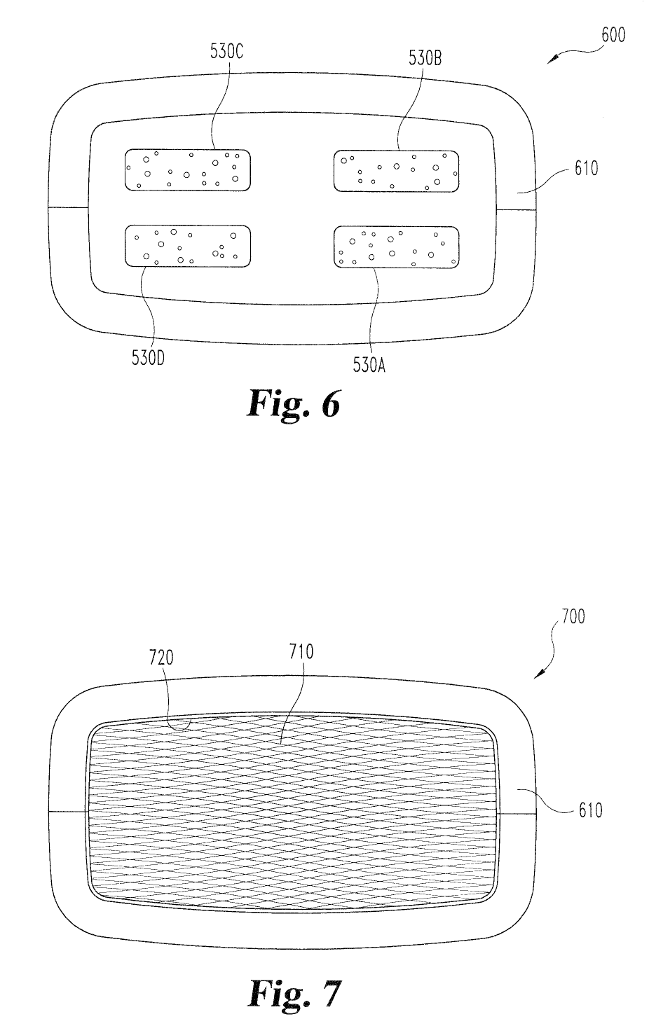

With reference to FIG. 6 there is illustrated operation 600 where several pieces of extruded mixture 530A, 530B, 530C and 530D have been sealed in a split mold 610. The pieces of mixture are heated in the mold to a temperature slightly above the solidus temperature of the metal or alloy of the mixture. The foaming agent has been selected to decompose at this temperature which releases a gas creating voids with a high internal pressure. The pressure created by the foaming agent causes the mixture to expand in a semi-solid flow which creates a foam that fills the mold.

With reference to FIG. 7 there is illustrated operation state 700 where operation 600 has been completed. In state 700, metal foam 710 has expanded to fill mold 610. In certain embodiments a partial or complete skin 720 may be formed on the exterior of metal foam 710, e.g., during and/or after the completion of operation 600.

It should be appreciated that additional processes may be used to form foam nanofiber composite materials which can be utilized in gas turbine engine components. For example, in the context of metal foams, composites of nanofiber and metal foams can be formed using melt gas injection techniques or gas releasing particle decomposition melt techniques where nanofibers are added to an alloy melt, or using casting techniques where nanofibers are introduced to a precursor such as a polymer which is then infiltrated to produce the foam. In the context of ceramic foams, nanofiber ceramic composites can be formed by introducing nanofibers into precursor slurries or mixtures which are then processed to form ceramic foams. In one example, foaming agents are added to the slurry. Polymerization is performed on the foamed slurry, followed by a drying process. Sintering then yields the product, e.g., the final foam product.

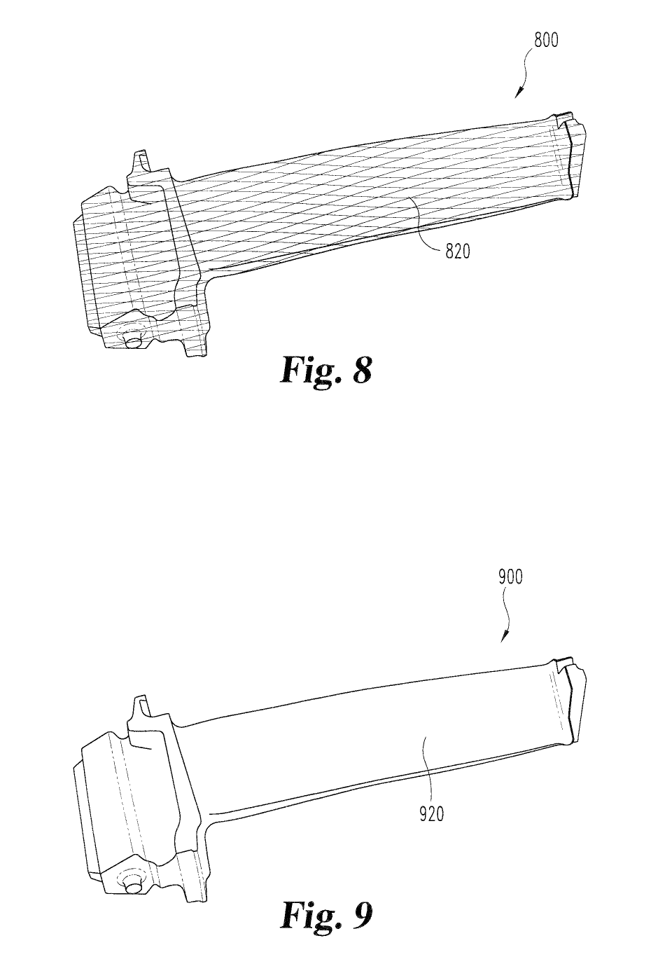

With reference to FIG. 8 there is illustrated operation state 800 where a composite material has been machined to provide the internal structure, e.g., body 820, of a turbine blade for a gas turbine engine. The composite material can be machined using a variety of techniques, only some of which are mentioned herein. In one embodiment the composite is machined using electrical discharge machining techniques which erode material in the path of an electrical discharge that arcs between an electrode tool and a composite. In another embodiment the composite material can be machined using water jet machining techniques where a pressurized stream of water which may include an abrasive is used to erode a composite to a desired shape. In an additional embodiment chemical milling is used to form the composite material into a desired shape. In a further embodiment laser cutting or ablation can be used form the composite material into a desired shape. In some embodiments, one or more of various mechanical cutting or grinding techniques may be employed.

With reference to FIG. 9 there is illustrated operation state 900 where a skin 920 has been formed on the internal structure, e.g., body 820. In one embodiment skin 920 is formed using spray casting techniques which utilize pressure-controlled atomization to apply a skin. Preferably the skin is a composite of metal and carbon nanofiber, although other skin compositions are also contemplated. In another embodiment skin 920 is formed using dip coating techniques. In one non-limiting example, carbon nanotubes can be added to metals, e.g., in the melt furnace, and either cast, forged or rolled at a mill to form the desired skin.

It should be understood that a variety of additional gas turbine engine components including a foam nanofiber composite can also be formed, such as, for example, blades and/or vanes. Other gas turbine engine components may include, for example and without limitation, shafts, discs, rotors, casings, struts, fans, compressors, turbines, and nozzles to name a few examples.

Embodiments of the present invention include an apparatus, comprising: a gas turbine engine component formed at least in part of a composite of metal foam and carbon nanofiber.

In a refinement, the composite forms an internal structure of the gas turbine engine component.

In another refinement, the gas turbine engine component is a rotational gas turbine engine component.

In yet another refinement, the gas turbine engine component is a blade.

In still another refinement, the apparatus further comprises a skin surrounding the composite.

In yet still another refinement, the skin includes metal and carbon nanofiber.

In an additional refinement, the composite includes carbon nanotubes.

In another additional refinement, the composite includes single walled carbon nanotubes.

In a further refinement, the composite forms an internal portion of the gas turbine engine component and a skin surrounds at least a portion of the composite.

In a yet further refinement, the skin includes a composite of metal and carbon nanotubes.

In a still further refinement, the composite includes a substantially random distribution of carbon nanofiber in a metal foam.

Embodiments of the present invention include an apparatus, comprising: a gas turbine engine component formed at least in part of a composite of ceramic foam and carbon nanofiber.

In a refinement, the composite comprises an internal structure of the gas turbine engine component.

In another refinement, the gas turbine engine component is a rotational gas turbine engine component.

In yet another refinement, the gas turbine engine component is a blade.

In still another refinement, the apparatus further comprises a skin surrounding the composite.

In yet still another refinement, the skin includes metal and carbon nanofiber.

In an additional refinement, the composite includes carbon nanotubes.

In another additional refinement, the composite includes single walled carbon nanotubes.

In a further refinement, the composite forms an internal portion of the gas turbine engine component and a skin surrounds at least a portion of the composite.

In a yet further refinement, the skin includes a composite of metal and carbon nanotubes.

In a still further refinement, the composite includes a substantially random distribution of carbon nanofiber in ceramic foam.

Embodiments of the present invention include an apparatus, comprising: a gas turbine engine component having a body formed at least in part of a cellular material reinforced with a plurality of carbon nanofibers; and a skin surrounding the body.

In a refinement, the cellular material includes a metal foam.

In another refinement, the cellular material includes a ceramic foam.

In yet another refinement, the nanofibers include nanotubes.

In still another refinement, the skin includes a composite of metal and carbon nanofiber.

In yet still another refinement, the gas turbine engine component consists essentially of a body including a cellular material reinforced with a plurality of carbon nanofibers and a skin surrounding the body.

In a further refinement, the gas turbine engine component includes an internal structure which consists essentially of a body including a cellular material reinforced with a plurality of carbon nanofibers and a skin surrounding the body.

In a yet further refinement, the nanofibers include carbon buckyballs.

In a still further refinement, the skin includes carbon buckyballs.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus, comprising: a gas turbine engine component formed at least in part of a composite of metal foam and carbon nanofiber.

2. The apparatus of claim 1, wherein the composite forms an internal structure of the gas turbine engine component.

3. The apparatus of claim 1, wherein the gas turbine engine component is a rotational gas turbine engine component.

4. The apparatus of claim 1, wherein the gas turbine engine component is a blade.

5. The apparatus of claim 1, further comprising a skin surrounding the composite.

6. The apparatus of claim 5, wherein the skin includes metal and carbon nanofiber.

7. The apparatus of claim 1, wherein the composite includes carbon nanotubes.

8. The apparatus of claim 1, wherein the composite includes single walled carbon nanotubes.

9. The apparatus of claim 1, wherein the composite forms an internal portion of the gas turbine engine component and a skin surrounds at least a portion of the composite.

10. The apparatus of claim 9, wherein the skin includes a composite of metal and carbon nanotubes.

11. The apparatus of claim 1, wherein the composite includes a substantially random distribution of carbon nanofiber in a metal foam.

12. An apparatus, comprising: a gas turbine engine component formed at least in part of a composite of ceramic foam and carbon nanofiber.

13. The apparatus of claim 12, wherein the composite comprises an internal structure of the gas turbine engine component.

14. The apparatus of claim 12, wherein the gas turbine engine component is a rotational gas turbine engine component.

15. The apparatus of claim 12, wherein the gas turbine engine component is a blade.

16. The apparatus of claim 12, further comprising a skin surrounding the composite.

17. The apparatus of claim 16, wherein the skin includes metal and carbon nanofiber.

18. The apparatus of claim 12, wherein the composite includes carbon nanotubes.

19. The apparatus of claim 12, wherein the composite includes single walled carbon nanotubes.

20. The apparatus of claim 12, wherein the composite forms an internal portion of the gas turbine engine component and a skin surrounds at least a portion of the composite.

21. The apparatus of claim 20, wherein the skin includes a composite of metal and carbon nanotubes.

22. The apparatus of claim 12, wherein the composite includes a substantially random distribution of carbon nanofiber in ceramic foam.

23. An apparatus, comprising:
a gas turbine engine component having a body formed at least in part of a cellular material reinforced with a plurality of carbon nanofibers; and
a skin surrounding the body.

24. The apparatus of claim 23, wherein the cellular material includes a metal foam.

25. The apparatus of claim 23, wherein the cellular material includes a ceramic foam.

26. The apparatus of claim 23, wherein the nanofibers include nanotubes.

27. The apparatus of claim 23, wherein the skin includes a composite of metal and carbon nanofiber.

28. The apparatus of claim 27, wherein the gas turbine engine component consists essentially of a body including a cellular material reinforced with a plurality of carbon nanofibers and a skin surrounding the body.

29. The apparatus of claim 23, wherein the gas turbine engine component includes an internal structure which consists essentially of a body including a cellular material reinforced with a plurality of carbon nanofibers and a skin surrounding the body.

30. The apparatus of claim 23, wherein the nanofibers include carbon buckyballs.

31. The apparatus of claim 23, wherein the skin includes carbon buckyballs.
